(19) United States
(12) Patent Application Publication
(10) Pub. No.: US 2004/0150516 A1
(43) Pub. Date: Aug. 5, 2004

(54) Wireless wheel speed sensor system

(75) Inventor: Steven E. Faetanini, Sandusky, OH (US)

Correspondence Address: Scott A. McBain, Esq., Delphi Technologies Inc., Legal Staff, Mail Code 480-410-202, P.O. Box 5052, Troy, MI, 48007-5052, US

(73) Assignee: Delphi Technologies, Inc., Troy, MI

(21) Appl. No.: 10/358,557

(22) Filed: Feb. 5, 2003

(51) Int. Cl. B60C 23/00

(52) U.S. Cl. 340/444

(57) ABSTRACT

A system and method for wirelessly transferring data between a plurality of vehicular sensors and an electronic communication unit. The system and the method further conserve energy by providing a method for controlling and intermittently transmitting data. The system further comprises a method and component whereby power may be generated and/or stored for use in powering the wireless vehicular wheel sensor transceivers. Finally, a system and method for identifying the vehicular sensors is also disclosed.

### TECHNICAL FIELD

The present invention relates generally to a system for two-way communication of information relating to the wheel of vehicle. More specifically, the present invention relates to a system for sensing wheel performance characteristics, e.g., rotational speed. The present invention also relates to wirelessly transmitting, receiving, and identifying data relating to the operation of a vehicle's wheels.

### BACKGROUND OF THE INVENTION

For a motorized vehicle to operate properly, many of its systems and components must routinely exchange information. For example, a vehicle's speedometer, which obviously informs a driver of the vehicle's speed, receives its data from a sensor that monitors the rotational speed of a vehicle's wheels. Similarly, the number of rotations of a vehicle's wheels provides the requisite data to the vehicle's odometer to inform a driver of the distance the vehicle has travelled. However, the transmission of data from a vehicular sensor to another component of a vehicle is often problematic. For example, sensors may be located in hard-to-reach places, or in places where wires or cables are simply either impractical or impossible to facilitate the transmission of data.

To address problems with wired sensors, various wireless systems for sensing the operating conditions of a vehicle have been developed. For example, wireless systems have been employed to monitor the pressure in a vehicle's tires and warn the driver of a hazardous low-pressure condition. It is also known to use a wireless system for monitoring the temperature of a vehicle's tires, as well as for monitoring the rotational speed of a vehicle's tires. Typically, these systems use a sensor, either integrally housed and mounted to the stem of a tire or, alternatively, positioned on the rim of a vehicle's tire. A radio frequency (RF) signal is used to wirelessly transmit the sensed data to a different location on the vehicle for processing. Examples of wireless vehicular sensing systems are shown in U.S. Pat. Nos. 5,289,160; 5,717,135; and 6,384,720, each of which is hereby incorporated by reference in its entirety.

Such wireless transmission of information is desirable for a number of reasons. First, it eliminates the time, effort, and costs involved during the initial installation of a particular vehicular sensor. Second, wireless wheel sensors are particularly desirable because the wires for data transmission and power at this location will typically be more exposed to adverse road elements such as thrown stones, water spray, and snow/ice accumulation, and can thus require more frequent maintenance. Moreover, wires running to wheels that turn can be more susceptible to premature wear due to the twisting that can occur as the wheels are turned.

Wireless vehicular sensors, however, have their own inherent problems. For example, if a vehicular sensor is fully wireless, it will neither have wires for transmission of data sensed by the sensor, nor wires for receiving power from a power source. As one solution to the absence of any wires supplying power to the vehicular sensors, passive sensors, which require no power, have been used in certain applications, such as monitoring tire pressure. However, the use of passive sensors is limited and, for other vehicular sensors, power is required. For these sensors, batteries have been used to provide an independent power source to each vehicular sensor, or, in the case of sensors associated with a vehicle's wheels, generators have been used to provide power to the sensors.

While independent batteries can provide power to independent vehicular sensors, such batteries require periodic maintenance to check, charge, and/or replace. Moreover, if such periodic maintenance is neglected, the batteries may die, rendering the associated sensor non-functional. Potentially, a vehicle with non-functioning sensors could display erroneous data to a driver, or, in the case of critical operating systems, such as a vehicle's anti-lock braking system (ABS), could raise serious safety concerns.

As an alternative to batteries, some vehicular wheel sensors employ generators to generate power for the sensor, based on the rotation of a vehicle's wheels. Generators, however, have an inherent limitation in that they require kinetic energy to generate power. In addition, even when the vehicle may be moving, if it is moving at too slow of a speed, a rotational wheel generator may not be able to provide the power required by the sensor.

Another problem inherently associated with wireless sensors is that, as the number of sensors on a particular vehicle increases, there may also be a corresponding increase in the difficulty of correctly identifying and differentiating data transmitted from each individual sensor. Moreover, the possibility of sensor signal confusion is further enhanced in larger vehicles, such as tractor-trailers, which may have 18 or more wheels. Similarly, in addition to potential problems in signal confusion between the sensors on a particular vehicle, there is also the potential for confusion with the transmission of wireless data from sensors or other sources, such as adjacent vehicles in a parking lot or highway.

Accordingly, there is a need to wirelessly monitor, at all times of operation and in all operating conditions, certain vehicular components and the data associated therewith, such as the rotational speed of a vehicle's wheels. There is also a need for a reliable and maintenance-free power source to provide for uninterrupted and convenient sensing and monitoring operations. There is also a need to be able to accurately identify and differentiate the signals from a plurality of vehicular sensors.

### SUMMARY OF THE INVENTION

The present invention overcomes the foregoing and other shortcomings and drawbacks of wireless vehicular sensor systems and methods heretofore known. While the invention will be described in connection with certain embodiments, it will be understood that the invention is not limited to these embodiments. On the contrary, the invention includes all alternatives, modifications and equivalents as may be included within the spirit and scope of the present invention.

The present invention provides a system and a method for wirelessly communicating data between active vehicular wheel sensors and a centralized electronic communication unit (ECU). This is accomplished through a plurality of wheel sensor transceivers which send data to, and receive data from, the ECU via RF signals. Standard RF modulation and demodulation further the data exchange.

The present invention also provides a power control subsystem whereby stored and generated voltage may be used to provide uninterrupted power to the sensor components. This power management subsystem utilizes a rotational wheel generator to create power when the vehicle is in motion and also a voltage storage device, such as a high-efficiency rechargeable battery or a super capacitor, to store and power the system when the generator is not producing power or the generated power is not sufficient to adequately power the sensors, such as when the vehicle is operating at slow speeds. A power controller then monitors and regulates when current is required to be drawn from the storage device, such as when the vehicle is stopped or moving very slowly.

Moreover, the present invention also provides a processor and a controller to regulate the frequency and amount of data communicated. A variety of methods can be used to transmit data intermittently, as well as to process and/or gate the signal data at the sensor transceiver level. This provides for additional energy conservation, as power is only needed when the sensor transceivers are processing or transmitting the data.

Finally, the present invention provides for the automatic identification of, and discrimination between, various active vehicular wheel sensors. This is accomplished through the assignment of sensor-specific and/or vehicle-specific digital codes to the various sensors, or, alternatively or additionally, by analysing the relative direction and/or signal strength of the various sensor transceiver signals. In other words, no physical identification components are required to be set or calibrated.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a diagrammatic view of a four-wheel vehicle showing a plurality of wheel sensors and a central electronic communication unit in accordance with the principles of the present invention;

FIG. 2 is a schematic view showing the four wheel sensors and the central electronic communication unit of FIG. 1 in accordance with one embodiment of the present invention;

FIG. 3 is a schematic view of a representative wheel sensor of FIG. 2 in accordance with the principles of the present invention;

FIG. 4 is a schematic view of the central electronic communication unit of FIG. 2 in accordance with the principles of the present invention;

FIG. 5 is a schematic view showing continuous data transmission from a vehicular wheel data sensor transceiver;

FIG. 6 is a schematic view showing periodic data transmission from a vehicular wheel data sensor transceiver;

FIG. 7 is a schematic view showing transmission of data from a vehicular wheel data sensor transceiver when there is a predetermined change in speed;

FIG. 8 is a schematic view showing processing of a speed signal and transmitting it from a vehicular wheel data sensor transceiver; and

FIG. 9 is a schematic view showing processing of a speed signal, and then only transmitting it from a vehicular wheel data sensor transceiver when there is a predetermined change in speed.

### DETAILED DESCRIPTION

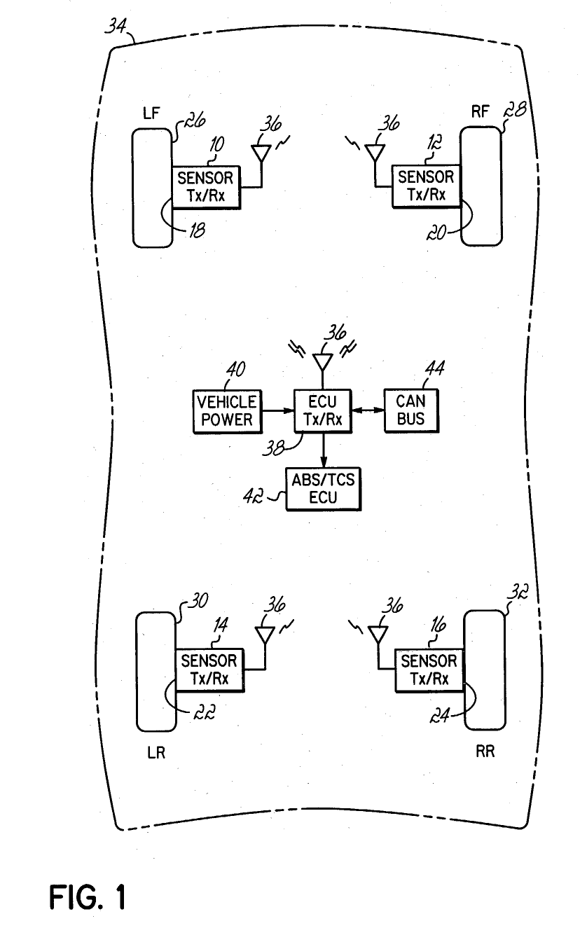

Referring to the Figures, and to FIG. 1 in particular, a plurality of vehicular wheel sensor transceivers 10, 12, 14, 16 are integrally mounted to the wheel bearings 18, 20, 22, 24 of the wheels 26, 28, 30, 32 of a vehicle 34. In one embodiment of the present invention, the vehicular wheel sensor transceivers 10, 12, 14, 16 are attached to the end cap of the bearing, to the seal packets in the bearing, or to another bearing component which would integrate the vehicular wheel sensor transceivers 10, 12, 14, 16 with the bearings assembly. However, the sensor transceivers could also be mounted elsewhere on the vehicle in other embodiments of the present invention.

Each vehicular wheel sensor transceiver 10, 12, 14, 16 is operatively connected to an antenna 36 by which data may be wirelessly transmitted to, and received from, a separately located electronic communications unit (ECU) transceiver 38 which is attached to an antenna 36. While wheel sensor transceivers 10, 12, 14, 16 are shown and described as comprising both transmit and receive capabilities in one embodiment, it is contemplated that wheel sensor transmitters, without a receive capability, could alternatively be used for transmitting sensed data only, without departing from the spirit and scope of the present invention. Likewise, while in one embodiment the ECU 38 uses a transceiver, in alternative embodiments, the ECU 38 could use a receiver only, particularly in embodiments where no sensor transceivers 10, 12, 14, 16 are used.

The ECU transceiver 38 and its components receive their power from the vehicle's 34 electric power grid 40. The ECU transceiver 38 is also operatively connected to the vehicle's 34 anti-lock braking system (ABS) and traction control system (TCS) 42. The ECU transceiver 38 is also operatively connected to a controller area network (CAN) communication bus 44 whereby it can communicate with other vehicular systems.

While FIG. 1 illustrates a vehicle 34 with only four wheels 26, 28, 30, 32, it can be appreciated that the present invention works equally well with a greater or lesser number of wheels 26, 28, 30, 32. Moreover, while the ECU transceiver 38 is illustrated near the center of the vehicle 34, in alternative embodiments, it could be positioned off-center, even at a point unequally distant from any vehicular wheel sensor transceiver 10, 12, 14, 16. Indeed, for signal identification purposes, it will often be desirable to position the ECU transceiver 38 at a position on the vehicle 34 whereby its relative distance from each vehicular wheel sensor transceiver 10, 12, 14, 16 will be different.

FIG. 2 illustrates a plurality of vehicular wheel sensor transceivers 10, 12, 14, 16 adapted for sensing the rotational speed 46a, 46b, 46c, 46d of the wheels 26, 28, 30, 32 of the vehicle 34. Any standard rotational wheel sensor, such as used in a typical ABS system, may be used. Such a sensor could be an active Hall effect, or magnetoresistive sensor, or a passive variable reluctance sensor.

In practice, the vehicular wheel sensor transceivers 10, 12, 14, 16 convert the rotational wheel speed 46a, 46b, 46c, 46d signal generated by a sensor 48 to a digital value, encode it, identify its source location, e.g., left-front wheel 26, right-front wheel 28, left-rear wheel 30, or right-rear wheel 32, modulate it, and transmit it to the ECU transceiver 38 via radio frequency (RF) waves. The ECU transceiver 38 receives the RF signals from the vehicular wheel sensor transceiver 10, 12, 14, 16, demodulates the signals, decodes the signals, verifies the signal identification, and converts the signals back into a speed signal that it communicates to the ABS/TCS control unit 42 or other vehicle 34 systems via the vehicle's 34 data bus 50. This system allows the vehicular wheel sensor transceivers 10, 12, 14, 16 to know when the ABS/TCS system 42 is active, i.e., when the vehicle's 34 ignition is activated. This system also permits acknowledgement of signal reception with the potential for error correction or retransmission.

Another advantage of the ECU transceiver's 38 ability to communicate with the plurality of vehicular wheel sensor transceivers 10, 12, 14, 16 is that it allows the ECU transceiver 38 to query the sensor 48 as well as download data to each individual sensor 48. For example, upon initial installation, the ECU transceiver 38 could query all active vehicular wheel sensor transceivers 10, 12, 14, 16 to provide an initial quality control check. In addition, the ECU transceiver 38 could request a reply signal which, based on the signal strength, its orientation, and/or direction, could indicate the relative location of the sensor transceivers 10, 12, 14, 16 on the vehicle 34.

The ability of the ECU transceiver 38 to download information to individual vehicular wheel sensor transceivers 10, 12, 14, 16, as one skilled in the art can appreciate, has many applications and advantages. For example, upon an initial installation calibration, during which the ECU transceiver 38 identifies the location of the various sensor transceivers 10, 12, 14, 16 on the vehicle 34, the ECU transceiver 38 could then download and assign a particular reference code to a particular sensor transceiver 10, 12, 14, 16. In addition to the ECU transceiver 38 identifying and assigning a reference code to each of the plurality of vehicular wheel sensor transceivers 10, 12, 14, 16, the ECU transceiver 38 could also download and assign a specific vehicular code to all of the sensor transceivers 10, 12, 14, 16 on a particular vehicle 34. This would allow for further discrimination between transmitted RF waves, particularly when vehicles 34 may be proximately located to one another, such as trucks at a loading dock, automobiles in a parking lot, or vehicles 34 on a highway in bumper-to-bumper traffic.

It can also be appreciated that the ability of the ECU transceiver 38 to download data to the vehicular wheel sensor transceivers 10, 12, 14, 16 allows it to effectively program and/or reprogram the various sensors 48. This is a significant advantage because, unlike conventional sensor transmitters that send all of their data to a central location for processing, in one embodiment of the present invention, signal processing can be accomplished at the sensor transceiver 10, 12, 14, 16 level. However, since the ECU transceiver 38 has the ability to communicate with the sensor transceivers 10, 12, 14, 16, any new or updated algorithms needed for processing at the sensor transceiver 10, 12, 14, 16 level need only be loaded to the ECU transceiver 38 for distribution down to the plurality of vehicular wheel sensor transceivers 10, 12, 14, 16.

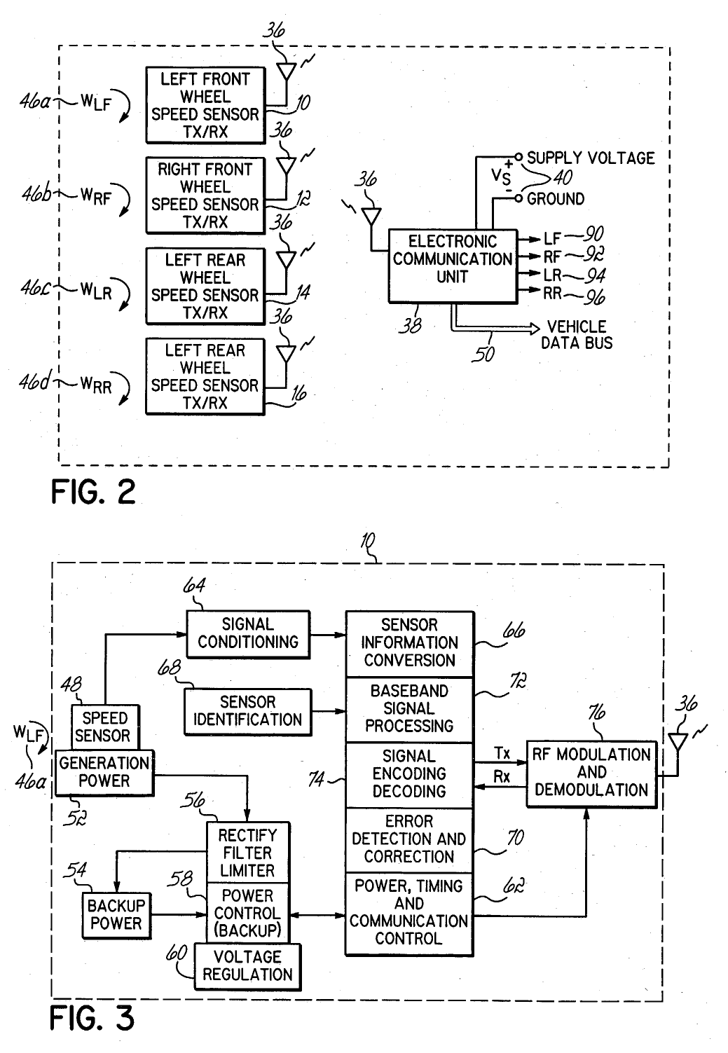

FIG. 3 illustrates the active vehicular wheel sensor transceiver 10. It will be appreciated that FIG. 3 is also representative of the other transceivers 12, 14, 16. In addition, while FIG. 3 specifically illustrates a vehicular sensor 48 adapted for sensing wheel speed rotation 46a, it can be appreciated that the sensor 48 could equally sense and monitor other vehicular wheel conditions, such as the temperature of the wheel bearings 18, 20, 22, 24, the number of rotations over the life of a particular bearing, tire pressure, wheel or tire temperature, or any other similar vehicular wheel operating parameters. It can further be appreciated that such information could be useful for preventative maintenance, for example, in monitoring the optimum time to replace the wheel bearings 18, 20, 22, 24 after so many rotations.

It can be appreciated by those skilled in the art that the vehicular wheel sensor transceiver 10 in one embodiment of the present invention would be constructed using various integrated circuit chips, a mixed signal micro-controller, a signal chip RF transceiver, a microprocessor, a supervisory chip, and other miscellaneous discrete components. These components would, in one embodiment, be mounted onto a printed circuit board. In addition, it should also be appreciated that other transceiver hardware and/or software could be used in other embodiments of the present invention.

The rotational wheel speed 46a serves an important function, regardless of what operating parameter is being sensed, for it provides the necessary energy to generate the necessary power required by the various sensor transceiver 10 components. Specifically, a generator 52 is used to generate a voltage as a result of the rotational wheel speed 46a. A rotational multi-polar generator, or any other vehicular wheel generator standard in the industry, could be used. What is unique about the power generation subsystem of the sensor transceivers 10, 12, 14, 16 is that it also provides for a power backup 54. The coupling of both a capability to generate power as well as a capability to essentially store power provides the sensor transceiver 10 the ability to operate at all speed conditions, including extremely low speeds or even when the vehicle 34 is at rest. The backup power source 54 could be a standard rechargeable battery, or a super capacitor, either of which could be charged and recharged, as needed by the generator 52. In addition to providing a wireless source of electricity, the combination of a power generator 52 and a power backup system 54 capable of being recharged by the generator 52 provides for an essentially maintenance-free power system, i.e., there is no need to change batteries.

The alternating current (AC) voltage that is generated by the power generator 52 is converted to direct current (DC) voltage by a rectify-filter-limiter 56. A power controller 58 monitors the DC voltage and provides automatic switch-over from the power generator 52 to the backup power source 54 when the rotational wheel speed 46a causes the generated DC voltage to fall below an acceptable voltage threshold to power the sensor transceiver 10. A voltage regulator 60 provides a stable voltage to the sensor transceiver 10, 12, 14, 16 components.

Another unique aspect of the sensor transceiver 10 is the power, timing, and communication (PTC) controller 62. The PTC controller 62 controls the power-saving modes of the system, the communication between the various sensor transceiver 10 features, and the timing of the serial data transmission from the sensor transceiver 10 to the ECU transceiver 38. As can be appreciated by those skilled in the art, one of the significant advantages of regulating the processing and transmission of data from the sensor transceiver 10 is that the sensor transceiver's 10 power can be conserved. This can become of particular importance when the vehicle 34 is stopped for a prolonged period of time, such as at a traffic signal or in a parking lot. The PTC controller 62 has the ability in those situations to reduce the transmissions from the sensor transceiver 10, and thus reduce the sensor transceiver's 10 energy consumption. In some situations, the PTC controller 62 could effectively put the sensor transceiver 10 into an inactive or sleep mode, whereby no data would be communicated unless the ECU transceiver 38 reactivated the sensor transceiver 10, i.e., sounded a wake-up call, and requested the resumption of data transmission.

The sensor transceivers 10, 12, 14, 16 also include various features and components that are common in the industry. For example, once a sensor 48, e.g., a speed sensor 48, senses a condition, a voltage signal corresponding to that condition is sent to a signal conditioner 64. Preferably, active sensors 48 are used to monitor a vehicle's 34 speed, as this will provide for a simpler signal conditioning circuit 64. The signal conditioner 64 filters and translates the voltage signal of the speed sensor 48 to a level compatible with the rest of the sensor transceivers' 10, 12, 14, 16 circuitry. The conditioned sensor 48 signal is then converted to a digital value by a sensor information converter 66. The sensor transceiver 10 also contains a sensor signal identifier 68, which uniquely identifies that particular sensor transceiver 10 signal with both a serial number to identify the sensor 48 location on the vehicle 34 as well as, potentially, a code identifying the vehicle 34 itself. This ensures that only the signals from a particular vehicle's 34 sensor transceivers 10, 12, 14, 16 are processed. All other signals can then be rejected by the ECU transceiver 38. This sensor identifier 68 may consist of a downloaded digital code and, as such, does not require the use of any external identifying components.

The sensor transceivers 10, 12, 14, 16 also contain an error detection and correction feature 70, which calculates a checksum based on the data value. It could also compare any received and calculated checksums. A baseband signal processor 72 combines the sensor 48 signal information with the sensor 48 signal identification code and adds a checksum to prepare the data for serialization and transmission. The signal encoder 74 then creates the serial data stream and encodes it as a binary pulse code modulated signal. The pulse code modulated signal is clocked into the RF modulator and demodulator 76. The RF modulator modulates the serial data stream on an RF carrier and transmits it through a power amplifier (not shown) to an antenna 36. The RF signal is then received by the ECU transceiver 38.

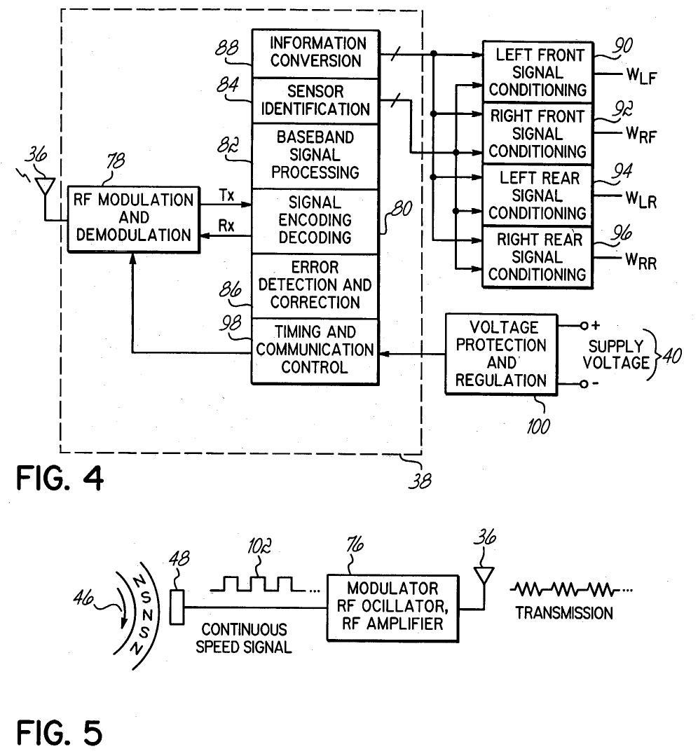

The ECU transceiver 38 can be further understood by reference to FIG. 4. Specifically, the ECU transceiver 38 transmits and receives signals to and from all the sensor transceivers 10, 12, 14, 16 through the antenna 36. An RF modulator/demodulator 78 modulates or demodulates a serial data stream, which is then decoded by a signal encoder/decoder 80. A baseband processor 82 extracts the sensor 48 signal data, the sensor 48 signal identifier, and the checksum from the data stream. A sensor transceiver identifier 84 compares the received sensor 48 identification code with the stored identification code for each vehicle sensor transceiver 10, 12, 14, 16. If the sensor 48 identification is valid, the signal is processed; otherwise, it is ignored. An error detection and correction feature 86 calculates a checksum based on the data and compares it with the received checksum. Any deviation can also result in ignoring the data or requesting a retransmission. A sensor 48 signal information converter 88 processes the digital data into a form compatible with the individual channel signal conditioner modules 90, 92, 94, 96. A timing and communication controller 98 controls the communication between various features and components of the ECU transceiver 38. The ECU transceiver 38 is powered from the vehicle 34 power grid 40 and is conditioned by a voltage protector and regulator 100.

Some of the novel features of the present invention can further be appreciated by reference to FIGS. 5 through 9. FIG. 5 illustrates a condition where the wheel speed signal 102 is continuously being transmitted from the sensor transceiver 10, 12, 14, 16 to the ECU transceiver 38. More specifically, the active sensing element 48 senses the rotational wheel speed 46 and sends a raw signal 102 directly to the RF oscillator and modulator 76 for direct transmission via the antenna 36 to the ECU transceiver 38. The wheel speed signal 102 directly controls the modulation of the RF oscillator and modulator 76, and thus, as long as there is a wheel speed signal 102, it will be transmitted, regardless of the speed or change of speed of the wheel 26, 28, 30, 32. Moreover, in this particular situation, the speed signal 102 is not processed, but is simply transmitted directly to the ECU transceiver 38 in its raw form.

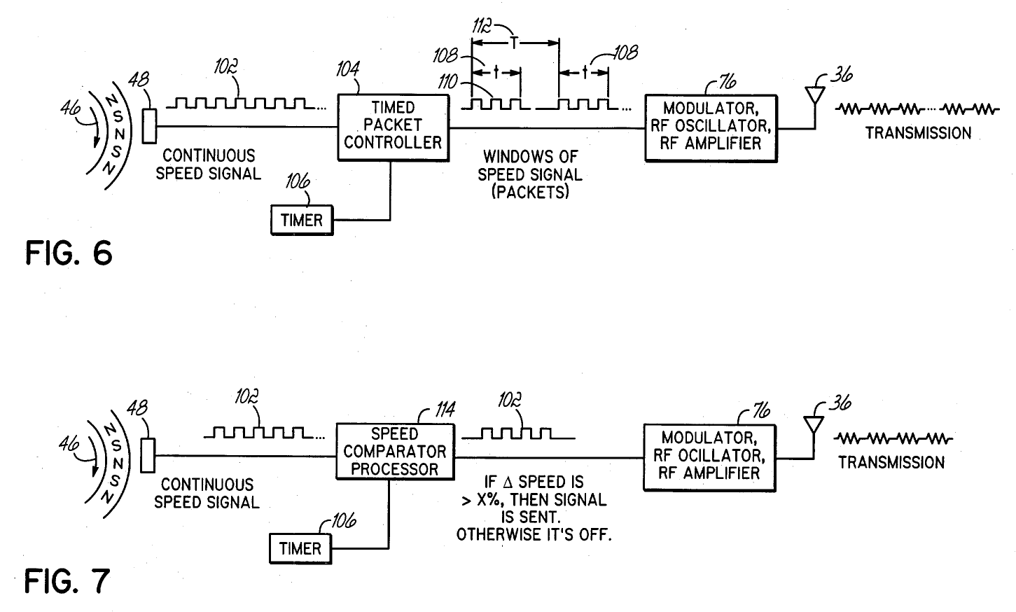

FIG. 6 illustrates a situation where the wheel speed signal 102 is transmitted only periodically to the ECU transceiver 38. Here, an active wheel speed sensor 48 continuously generates the wheel speed signal 102. However, a timed packet controller 104, which is operatively connected to a timer 106, controls what data is sent to the RF modulator, RF oscillator, and RF amplifier 76. While the timed packet controller 104 and the timer 106 are shown in FIG. 6 in separate blocks, it can be appreciated that they could be integral with each other, as well as part of the PTC controller 62. Specifically, the timed packet controller 104 controls the amount of data that will be sent to the modulator 76 by controlling the amount of time “t” 108 for which data will be bundled into packets 110. In addition to the amount of data that the timed packet controller 104 forwards, the timed packet controller 104 also controls the frequency at which the packets of data 110 are forwarded. Thus, the time “t” 108 controls the amount of wheel speed data 102 in a particular packet 110, whereas the time “T” 112 controls how often wheel speed data 102 is sent to the modulator 76. The packetized wheel speed signal 110 also controls the modulation of the RF oscillator modulator 76. The modulator 76 in turn transmits intermittently an RF signal via its antenna 36 to the ECU transceiver 38. In an alternative embodiment of this system and procedure, the time “T” 112 could be varied so as not to coincide with the transmission from any other sensor transceiver 10, 12, 14, 16. Moreover, the time “t” 108 could be adjusted, depending on the amount of speed data 102 needed by the ECU transceiver 38 to determine wheel speed 46.

FIG. 7 illustrates yet another embodiment of the present invention. Here, an active wheel speed sensor 48 again monitors the rotational wheel speed 46 and generates a continuous speed signal 102. In this embodiment, however, a speed comparator processor 114 integral with, and part of, the sensor transceivers 10, 12, 14, 16 compares various raw wheel speed signals 102 generated by the active wheel sensor 48. A timing function 106 is used to determine periods of time for which speed signals will be compared. In this situation, when the raw speed signal 102 changes by some predetermined amount, for example, some percentage, the speed signal 102 is then forwarded to the modulator 76. However, if the relative raw wheel speed signals 102 are steady, or nearly steady, then no speed data is forwarded to the modulator 76. In other words, the modulation will only be triggered when there is a predetermined raw speed signal 102 differential. When such is the case, the modulator 76 transmits the signal via its antenna 36 to the ECU transceiver 38. This ability for intermittent transmissions further helps to conserve the sensor transceivers' 10, 12, 14, 16 power supply 54.

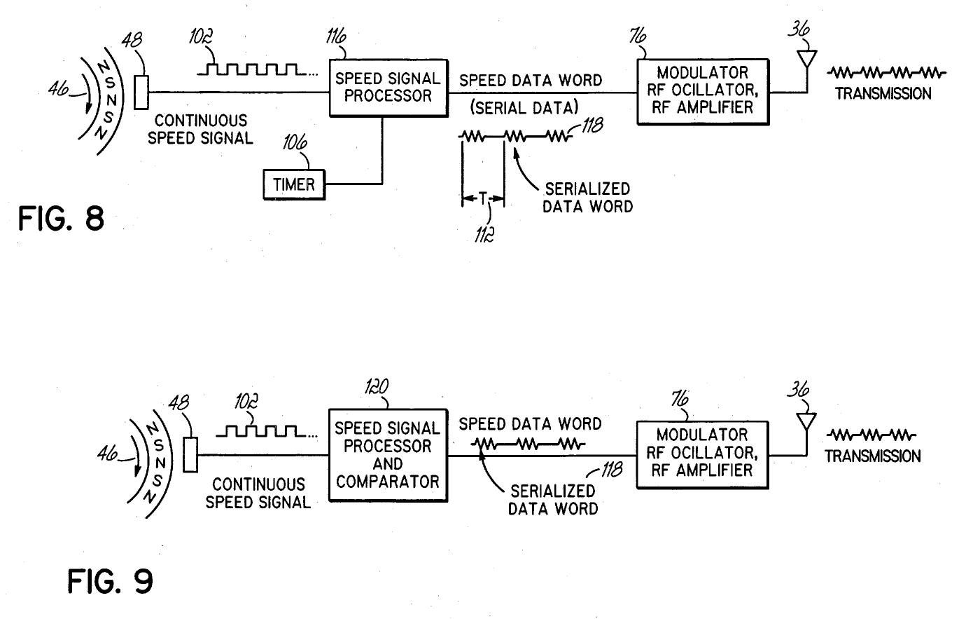

The embodiment of the present invention shown in FIG. 8 illustrates how a sensor transceiver 10, 12, 14, 16 can conduct some signal processing prior to transmitting to the ECU transceiver 38. Here again, an active wheel speed sensor 48 generates a continuous speed signal 102 based on the rotational wheel speed 46 of the wheels 26, 28, 30, 32 of the vehicle 34. However, in this particular embodiment, the sensor transceivers 10, 12, 14, 16 further contain a speed signal processor 116. The speed signal processor 116 calculates the actual wheel speed 46 from the raw speed signal data 102. This serialized data 118 is then periodically gated to the modulator 76. The time “T” 112, as set by the timer 106, controls the frequency of the speed data transmission. While the speed signal processor 116 and the timer 106 are shown in FIG. 8 in separate blocks, it can be appreciated that they could be integral with each other, or part of another sensor transceiver 10, 12, 14, 16 component. In this embodiment, the modulation of the RF oscillator modulator 76 is determined by the speed signal processor timer 106. However, in alternative embodiments, it could be appreciated that a processed speed signal 102 could be continuously forwarded to the modulator 76 for continuous transmission, as was illustrated in FIG. 5. In such a situation, the timer 106 would not be necessary. One advantage of having the speed signal 102 processed at the sensor transceiver 10, 12, 14, 16 level is that the ECU transceiver 38 does not have to process raw speed data 102. Such a system of decentralized data processing can allow for more efficient and effective operations. Finally, once again, the use of the timer 106 contributes to energy conservation at the sensor transceiver 10, 12, 14, 16 level.

The embodiment of the present invention illustrated in FIG. 9 also shows a configuration where processing of the speed signal 102 is done at the sensor transceiver 10, 12, 14, 16 level. Specifically, the active wheel speed sensor 48 senses the rotational wheel speed 46 and generates a continuous speed signal 102. As in FIG. 8, a speed signal processor 120 then calculates the actual wheel speed 46 from the raw speed signal data 102. In this example, however, a speed signal comparator 120, which is illustrated integral with the speed signal processor 120, then compares the signals and will only forward the serialized data 118 if there is some predetermined change in the speed. Thus, as in FIG. 7, if the actual speed signal 102 changes by a certain amount or percentage, the speed data is forwarded to the modulator 76 for transmission via its antenna 36 to the ECU transceiver 38. Thus, in this example, the modulation is controlled, as in FIG. 7, by a speed signal 102 differential. As before, the intermittent transmissions conserve the energy resources of the various sensor transceivers 10, 12, 14, 16.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of Applicant's general inventive concept.

What is claimed is:

1. A wireless vehicular communication system comprising:
a wireless vehicular data sensor;
an electronic communication unit;
a wireless transceiver operatively connected to the wireless vehicular data sensor for transmitting sensed data to the electronic communication unit; and
a vehicular sensor data transceiver operatively connected to the electronic communication unit and in wireless communication with the wireless transceiver for receiving data from the sensor.

2. The wireless vehicular communication system of claim 1 wherein the vehicular sensor data receiver is in wireless communication with a plurality of vehicular sensor wireless transceivers.

3. The wireless vehicular communication system of claim 1 wherein the wireless vehicular data sensor is a vehicular wheel data sensor.

4. The wireless vehicular communication system of claim 3 wherein the vehicular wheel data sensor is an active sensor.

5. The wireless vehicular communication system of claim 3 wherein the vehicular wheel data sensor is a rotational wheel speed sensor.

6. The wireless vehicular communication system of claim 3 wherein the vehicular wheel data sensor is mounted to the wheel bearings.

7. The wireless vehicular communication system of claim 1 wherein the wireless vehicular data sensor contains a sensor signal processor.

8. The wireless vehicular communication system of claim 1 wherein the wireless vehicular data sensor contains a speed comparator.

9. The wireless vehicular communication system of claim 1 wherein the wireless vehicular data sensor contains a communication controller.

10. The wireless vehicular wheel communication system of claim 9 wherein the communication controller contains a timed data packetizer.

11. The wireless vehicular communication system of claim 1 wherein the electronic communication unit contains a sensor signal identifier adapted to identify and differentiate a plurality of the vehicular data sensors.

12. The wireless vehicular communication system of claim 111 wherein the sensor signal identifier is adapted to identify and differentiate a plurality of the vehicular data sensors without the use of any vehicular data sensor hardware identification codes.

13. The wireless vehicular communication system of claim 11 wherein the sensor signal identifier is adapted to identify and differentiate a plurality of the vehicular data sensors without the use of any preset vehicular data sensor software identification codes.

14. The wireless vehicular communication system of claim 1 further comprising a power source operatively connected to the wireless vehicular sensor.

15. The wireless vehicular communication system of claim 14 wherein the power source further comprises:
a voltage generator;
a backup power source; and
a power source controller operable to select power from one of the voltage generator and the backup power source to provide power to the sensor.

16. The wireless vehicular communication system of claim 15 wherein the voltage generator is a rotational multi-polar generator.

17. The wireless vehicular communication system of claim 15 wherein the backup power source comprises a rechargeable battery.

18. The wireless vehicular communication system of claim 15 wherein the backup power source comprises a super capacitor.

19. A vehicular communication system comprising:
a vehicular data sensor;
an electronic communication unit;
a transmitter operatively connected to the wireless vehicular data sensor for transmitting sensed data to the electronic communication unit;
a vehicular sensor data receiver operatively connected to the electronic communication unit and in communication with the transmitter for receiving data from the sensor; and
a power source operatively connected to the vehicular sensor comprised of a voltage generator, a backup power source, and a power source controller operable to select power from one of the voltage generator and the backup power source to provide power to the sensor.

20. The vehicular communication system of claim 19 wherein the backup power source is a rechargeable battery.

21. The vehicular communication system of claim 19 wherein the backup power source is a super capacitor.

22. A wireless vehicular communication system comprising:
a plurality of wireless active vehicular rotational wheel speed data sensors mounted to each set of wheel bearings and containing a sensor signal processor, a speed comparator, a communication controller, and a timed data packetizer;
a power source operatively connected to each wireless active vehicular rotational wheel speed data sensors comprised of a rotational multi-polar voltage generator, a backup power source, and a power source controller operable to select power from one of the voltage generator and the backup power source to provide power to the sensor;
a vehicular sensor wireless transceiver operatively connected to the wireless active vehicular rotational wheel speed data sensor;
a vehicular sensor data receiver in wireless communication with the vehicular sensor wireless transceiver; and
an electronic communication unit operatively connected to the vehicular sensor data transceiver and containing a sensor signal identifier adapted to identify and differentiate a plurality of the vehicular data sensors without the use of any vehicular data sensor hardware or any preset software identification codes.

23. The wireless vehicular communication system of claim 22 wherein the backup power source comprises a rechargeable battery.

24. The wireless vehicular communication system of claim 22 wherein the backup power source comprises a super capacitor.

25. A method for transmitting wheel speed signals comprising the steps of:
continuously sensing the rotational speed of a wheel;
continuously generating raw wheel speed signals;
continuously modulating the generated wheel speed signals into radio frequency signals;
continuously amplifying the radio frequency signals; and
continuously transmitting the amplified radio frequency signals to a receiver/controller.

26. A method for transmitting wheel speed signals comprising the steps of:
sensing the rotational speed of a wheel;
continuously generating raw wheel speed signals;
packetizing the generated wheel speed signals for a predetermined time period with a timed packet controller;
intermittently modulating packetized wheel speed signals into radio frequency signals;
intermittently amplifying the radio frequency signals; and
intermittently transmitting the amplified radio frequency signals to a receiver/controller.

27. The method of claim 26 wherein the intermittent transmission of the amplified radio frequency signal to a receiver/controller is staggered so as not to coincide with the transmission of another amplified radio frequency signal to the receiver/controller.

28. A method for transmitting wheel speed signals comprising the steps of:
sensing the rotational speed of a wheel;
continuously generating raw wheel speed signals;
comparing the generated raw wheel speed signals with a speed comparator processor to determine if there is a difference between the generated raw wheel speed signals of more than a predetermined amount;
modulating wheel speed signals into radio frequency signals when there is a difference between the generated raw speed signals of more than the predetermined amount;
amplifying the radio frequency signals when there is a difference between the generated raw speed signals of more than the predetermined amount; and
transmitting the amplified radio frequency signals to a receiver/controller when there is a difference between the generated raw speed signals of more than the predetermined amount.

29. A method for transmitting wheel speed signals comprising the steps of:
sensing the rotational speed of a wheel;
continuously generating raw wheel speed signals;
calculating the actual wheel speed from the raw wheel speed signal using a speed signal processor;
serializing the actual wheel speed data;
modulating the serialized actual wheel speed signals into radio frequency signals;
amplifying the radio frequency; and
transmitting the amplified radio frequency signals to a receiver/controller.

30. The method of claim 29 further comprising the step of periodically gating the serialized actual wheel speed data to a modulator.

31. A method for transmitting wheel speed signals comprising the steps of:
sensing the rotational speed of a wheel;
continuously generating raw wheel speed signals;
calculating the actual wheel speed from the raw wheel speed signal using a speed signal processor;
serializing the actual wheel speed data;
comparing the serialized actual wheel data with a speed comparator processor to determine if there is a difference between the serialized wheel speed data of more than a predetermined amount;
modulating the serialized actual wheel speed data into radio frequency signals when there is a difference between the serialized wheel speed data of more than the predetermined amount;
amplifying the radio frequency signals when there is a difference between the serialized wheel speed data of more than the predetermined amount; and
transmitting the amplified radio frequency signals to a receiver/controller when there is a difference between the serialized wheel speed data of more than the predetermined amount.

32. The method of claim 31 further comprising the step of gating the serialized actual wheel speed data to a modulator when there is a difference between the serialized wheel speed data of more than the predetermined amount.
